(19) United States
(12) Patent Application Publication
(10) Pub. No.: US 2011/0192785 A1
(43) Pub. Date: Aug. 11, 2011

(54) HYDRATION PACK

(75) Inventors: Michael Pritchard, Ipswich (GB); Sally Ann Pritchard, Ipswich (GB)

(73) Assignee: PRITCHARD IP LIMITED, Puckeridge, Hertfordshire (GB)

(21) Appl. No.: 13/120,151

(22) PCT Filed: Sep. 29, 2009
(86) PCT No.: PCT/GB2009/002324

§ 371 Date: Apr. 26, 2011

Related U.S. Application Data
(60) Provisional application No. 61/102,162, filed on Oct. 2, 2008.

(51) Int. Cl. B67D 7/36; B67D 7/06; B67D 7/76

(52) U.S. Cl. 210/419; 222/189.06; 222/192; 239/663; 239/575

(57) ABSTRACT

A hydration pack (10) includes a bladder (11) attached to a pump (12) via a feed tube (13) and to a bite valve mouthpiece (14) via a drinking tube (15). The bladder (11) incorporates a filter cartridge (16) which is capable of ultra-filtration and thereby effective to remove viruses as well as bacteria from water. The filter cartridge (16) is coupled to the drinking tube (15) such that any water that passes from the bladder (11) to the mouthpiece (14) must pass through the filter cartridge (16). The pump (12) is able to act both to transfer water into the bladder and also to pressurize the bladder with air.

### BACKGROUND TO THE INVENTION

For those engaged in active outdoor pursuits who require drinking water it is common for such people to carry their own supply of water with them. Although it may be the case that there is no other source of water available en route, it is also true to say that they are unwilling to stop and drink from an open, untreated water source because of the risk of contamination.

A popular solution to this problem has been to provide a water bladder with a drinking tube and mouthpiece attached, known as a personal hydration pack. The water bladder can be placed inside existing baggage such as a rucksack, and the tube and mouthpiece essentially act as a straw—the user takes the mouthpiece into the mouth and sucks in order to extract water from the bladder. A typical mouthpiece includes a bite valve to control the flow of water and a locking valve to isolate the bladder from the mouthpiece and thereby prevent leakages.

A locking valve is necessary because the bite valve is not sufficiently effective to be relied upon at all times. There is small but significant loss of water while the locking valve is open, even if the bite valve is closed. This is because by the act of simple motion and/or the bite valve banging against other objects a small amount of water is let by. Over time, the bite valve also wears through constant biting.

Although personal hydration packs have proven to be a great advance over traditional water bottles, they do suffer from some drawbacks. In particular, it is often difficult for the user to quickly draw an acceptable flow of water from the bladder. It should be understood that every breath the user spends drawing water from the bladder is one less breath that can be used to deliver oxygen to the user's body.

A further complication arises when the water in the bladder needs to be replenished. When the bladder is placed in a rucksack, for example, the user will be required to remove the rucksack, extract the bladder, and remove the bladder closure (typically a screw fitting or clip) before refilling it with water. In practice, a number of other steps are required, for example it is often necessary to remove the drinking tube and the mouthpiece.

Hydration packs are now commonly used by soldiers, who require drinking water while operating in hostile environments. Clearly, removing the soldier's backpack and then extracting the bladder in order to place it in an available water source, such as a river or a stream, puts the soldier in a vulnerable position.

Users generally also face the problem of the water heating up inside the bladder and in the drinking tube, making the water extremely unpalatable to drink. It is known to address this problem (with limited success) by enclosing the bladder and drinking tube in an insulating sleeve.

Users often use the water to cool themselves down. Conventional extraction of water from hydration packs for this purpose, unless it is drawn directly into the mouth is cumbersome. The user must hold the bite valve below the level of the water inside the bladder, squeeze the bite valve by hand and empty some water onto his or her hand or head etc. It will be understood that this can be quite a wasteful use of water.

### SUMMARY OF THE INVENTION

According to the present invention, there is provided a hydration pack comprising:

a hydration bladder for holding water;
a drinking tube coupled to the hydration bladder, the drinking tube having a bite valve mouthpiece for controlling the flow of water from the hydration bladder; and,
a pump having a fluid inlet for drawing in fluid under the action of the pump and a fluid outlet coupled to the hydration bladder for transferring said fluid to the hydration bladder,
wherein the pump is operative to transfer water and air from the pump inlet to the pump outlet to enable the hydration bladder to be filled with water from a source and subsequently be pressurised with the air.

The present invention provides a hydration pack that includes a pump that is able to act both to transfer water from a source of water into the hydration bladder, and also to pressurise the hydration bladder with air. In other words, it can pump water and it can pump air. As a consequence, unlike with conventional hydration packs the hydration bladder itself need not be physically removed and opened (usually by removing a closure) for filling with water. When the hydration bladder is then pressurised with air it allows a user to obtain a steady stream of water from the hydration bladder through the bite valve without requiring any suction at the mouthpiece. This has the additional advantage of allowing the user to continue to breath relatively easily whilst drinking water from the hydration pack.

Preferably, the hydration pack further comprises a water filter in-line between the pump outlet and the bite valve. Most preferably, the water filter is located within the hydration bladder. The water filter improves the drinking quality of the water, which may be important if the water comes from an open or otherwise untreated source which is liable to be contaminated. Preferably, the water filter is removable from the hydration bladder.

Preferably, the water filter comprises one or more hollow fibre membranes which are effective to pass water in preference to air under the influence of a pressure differential which drives or draws water through the membranes.

A suitable form of water filter cartridge is described in International patent application number PCT/GB2007/003623 (International publication number WO2008/037969) filed on 25 Sep. 2007. Filter cartridges of this type are have a mean pore size which is capable of ultra-filtration and are thereby effective to remove viruses as well as bacteria from the water. In preferred embodiments, a pump provides a pressure differential to drive or draw water through the walls of the hollow fibre membranes and thereafter along the length of the fibre membranes to the mouthpiece when the bite valve is opened.

Preferably, the bite valve mouthpiece comprises a valve member having a valve opening and a bulldog clip closure which normally closes the valve opening to prevent the flow of water, the bulldog clip being flexed open when a user bites down to release the valve opening and thus allow water to flow through the mouthpiece.

The bulldog clip closure preferably comprises two arms disposed around a pivot region, the arms having corresponding bite regions and constriction regions disposed on opposite sides of the pivot region, and the arms being biased towards a position in which constriction regions of each arm are urged toward each other to seal the valve member. This preferred bite valve is significantly more effective than previous bite valves used in hydration packs. A user need only bite the bite regions of the valve in order to unseal the drinking tube, and allow a stream of water to be expelled. However, once the user releases the bite regions, the valve seals the drinking tube closed.

Preferably, the bite valve comprises an atomiser portion actuable to deliver a spray mist of water.

Although the preferred bite valve finds particular utility in the hydration pack of the present invention it will be understood that such a bite valve could be used independently of this for other applications.

In preferred embodiments the hydration pack is adapted such that it may be directly attached to a soldiers clothing and load carriage systems using clips or other attachment devices. In particular, it is provided with clips that allow it to be attached to a molle based system incorporating PALS (Pouch Attachment Ladder System), a grid of webbing invented by the United States Army Natick Soldier Research, Development and Engineering Center and used for example in the British Army's Osprey™ body armour.

Preferably, the hydration bladder is flexible enough so that when empty it may be rolled up in a tight tube and stored. This reduces the volume of storage that it takes up when not in use. When rolled or folded the attachment devices used to hold it to the PALS system can also be clipped together holding the shape of the bladder for easy storage. Preferably, the hydration bladder includes a pressure relief valve which prevents the bladder from becoming over-pressurised. The hydration bladder may be provided with a removable closure to allow the bladder to be filled in a conventional manner rather than be filled via the pump, and also to allow the water filter (if provided) to be removed.

Preferably, the pump is manually actuated. Preferably, the pump includes a pressure regulator to release pressure when it passes a predetermined threshold value. The pump is preferably capable of creating a pressure up to 5 bar.

Preferably, the hydration pack incorporates evaporative cooling materials to provide evaporative cooling for the hydration bladder and/or the drinking tube. When these materials are wetted water is adsorbed into the materials. Through the physics of evaporation, heat is drawn from the drinking water in the hydration bladder and the drinking tube through the adsorbent materials to help cool the drinking water. Suitable evaporative cooling materials include cotton, linen, canvas, non-woven synthetic material, Cordura™ from DuPont, cellulose sponge cloth, and other highly adsorbent materials. These materials can be used to encase the hydration bladder and/or the drinking tube. Highly adsorbent gels, such as silica gels, may also be incorporated to further enhance the evaporative cooling effect. Furthermore the drinking tube and the hydration bladder may be made from a thermo-conductive plastic. This makes the evaporative cooling process even more effective.

### BRIEF DESCRIPTION OF THE DRAWINGS

Embodiments of the present invention will now be described in detail with reference to the accompanying drawings, in which:

FIG. 1 shows a schematic representation of a preferred embodiment of a hydration pack in accordance with the present invention;

FIGS. 2 and 3 illustrate a preferred example of a dual-purpose hand pump shown in FIG. 1;

FIGS. 4 to 7 illustrate a preferred example of a bite valve main piece shown in FIG. 1;

FIGS. 8 and 9 illustrate a number of preferred evaporative cooling structures for use with the hydration pack shown in FIG. 1; and,

FIG. 10 shows a hydration pack in accordance with the present invention when fitted to the back of a soldier.

### DETAILED DESCRIPTION

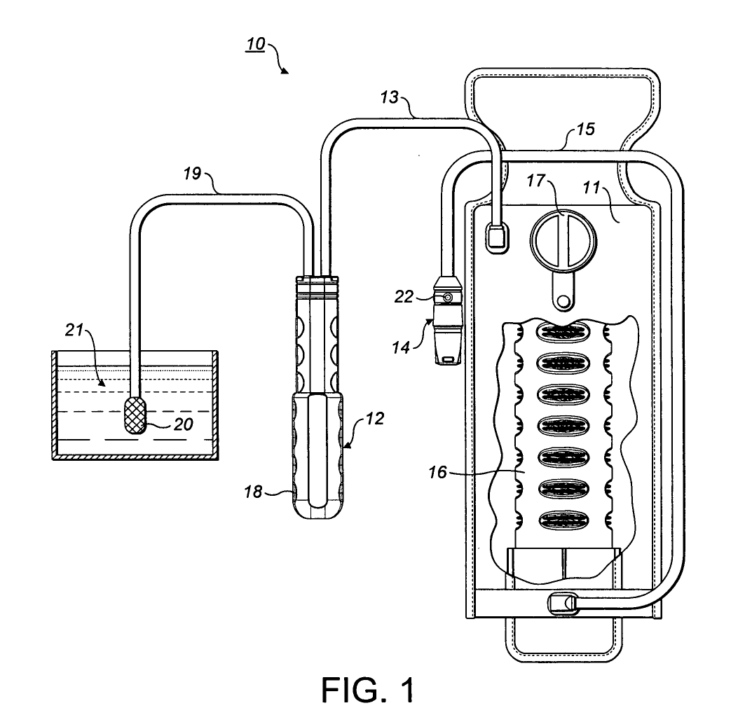

FIG. 1 illustrates a preferred embodiment of a hydration pack 10 in accordance with the present invention. As shown, a bladder 11 (shown partially exposed) is attached to a pump 12 via a feed tube 13 and to a bite valve mouthpiece 14 via a drinking tube 15. The bladder 11 incorporates a filter cartridge 16 (described in more detail below). The filter cartridge 16 is coupled to the drinking tube 15 such that any water that passes from the bladder 11 to the mouthpiece 14 must pass through the filter cartridge 16. The filter cartridge 16 may be removably secured within the bladder 11 using a screw fitting (not shown). A removable closure 17 is provided to allow the bladder 11 to be filled in a conventional manner when required.

The pump 12 is actuated manually via a pump handle 18, although other forms of pump may be used. A scavenging hose 19 is coupled to the pump 12 at its proximal end. A pre-filter 20 is fitted at the distal end of the scavenging hose 19. In use, the distal end of the scavenging hose 19 is immersed or otherwise coupled to a source of water 21, shown schematically in the Figure. The pump 12 may then be used to pump water from the source 21 into the bladder 11 via the scavenging hose 19, the pump 12, and the feed tube 13. The use of the pump 12 to fill the bladder 11 means the user does not need to remove the bladder from its storage position (for instance, on the user's back) in order to fill it with water.

When the scavenging hose 19 is removed from the water source 21, continued operation of the pump 12 pumps air into the bladder 11 to increase the internal pressure. The pump 12, therefore, can be used both to fill the bladder with water and subsequently to pressurise it with air.

In order to drink from the hydration pack 10, the user merely bites down on the mouthpiece 14 to open a bite valve within (described in detail below) which then releases a stream of filtered water from the bladder 11 without needing to suck the mouthpiece 14.

The mouthpiece 14 also includes a spray head 22. As will be described below, the user is able to activate the spray head 22 such that pressure within the bladder 11 releases a spray of water. This is particularly useful should the user wish to use water stored in the bladder 11 for cooling their body.

In a preferred embodiment, the bladder 11 is made from a lamination of materials forming a single water load carriage mechanism. Whilst the material is flexible and can easily be folded for compact storage, the bladder is constructed in such as way that upon the introduction of internal pressure the bladder takes its predetermined shape and remains in this shape. It is designed not to expand. This is done through the use of a combination of laminates that have flexibility in one axis but have rigidity in another. The laminates could include a tough nylon weave. In some embodiments, the weave includes a wire mesh. Moreover, the weave may also include some stab proof/bullet proof materials to afford protection to the bladder and the user. The laminate material typically includes at least an outer layer (such as canvas), and an inner, waterproof layer.

The filter cartridge 16 is preferably of the type described in International patent application number PCT/GB2007/003623 (International publication number WO2008/037969) filed on 25 Sep. 2007. Filters of this type are made from a matrix of hollow fibre membranes which typically have a mean pore size which is capable of ultra-filtration. As such, the filter cartridge 16 is effective to remove bacteria, viruses, cysts, parasites, fungi and all other water-born pathogens. In fact, such a filter removes all microbiological matter from the water to provide safe, sterile drinking water.

The fibre membranes used in preferred embodiment of the present invention have a retention of greater than log 6 (99.9999%) of bacteria, cysts, parasites and fungi, and greater than log 4 (99.99%) of viruses from the water. The fibre membranes also remove sediments and other deposits from the water.

The pump 12 provides the required pressure differential to drive water through the walls of the hollow fibre membranes and thereafter along the length of the fibre membranes to the mouthpiece 14 when the bite valve within is opened.

Providing a filter cartridge 16 such as that described above allows the user to use water from a wide range of sources, including open sources of water, that is effectively rendered safe to drink.

Fibre membranes suitable for use with the present invention are available commercially, for example X-flow (TM) capillary membranes from Norit (www.norit.com) may be used. This hollow fibre ultra-filtration membrane is effective to screen all turbidity, bacteria as well as viruses.

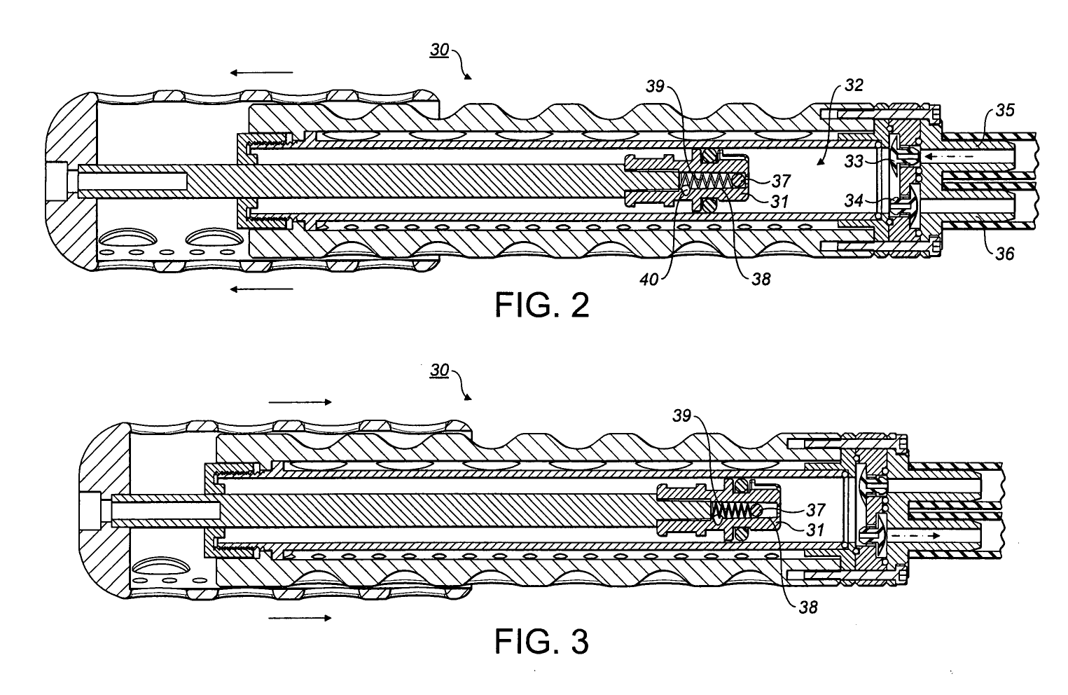

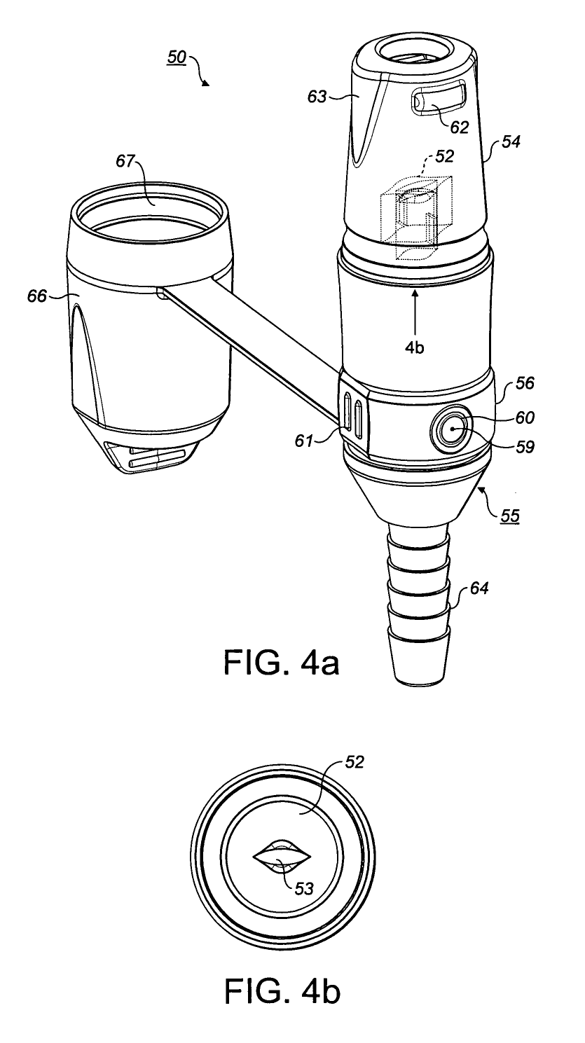

FIGS. 2 and 3 show cross-sections of an example of a dual-purpose mechanical pump 30 for use in the hydration pack 10 of FIG. 1. FIG. 2 shows the pump head 31 after it has been partially withdrawn along the pump chamber 32. FIG. 3 shows the pump head 31 towards the end of a return stroke.

Mushroom-shaped non-return valves 33, 34 are disposed adjacent to each of an input port 35 and an output port 36, respectively. When the pump head 31 is withdrawn the pressure differential created is sufficient for the non-return valve 33 associated with the input port 35 to be displaced (as indicated by the arrow in FIG. 2) to let fluid pass into the pump chamber. When the pump head 31 is returned up the pump chamber 32 the return valve 33 at the input port 35 closes, while the non-return valve 34 associated with the output port 36 is displaced (as indicated by the arrow in FIG. 3) to allow fluid to pass out of the pump chamber.

Once the bladder has been pressurised with air by the pump, the associated pressure differential is effective to bias the non-return valve 34 at the output port 36 closed. It will only open when the pump is actuated to overcome this bias.

The internal pressure in the bladder is regulated by a ball bearing 37 disposed within a passageway 38 within the pump head 31. The ball bearing 37 is biased towards the end of the pump head 31 by a spring 39. As shown in FIG. 3, the ball bearing retracts down the passageway by a distance depending on the applied pressure. If the applied pressure reaches a pre-determined maximum level then the ball bearing 37 is retracted to such an extent that fluid may pass through a passageway 40 and behind the pump head 31 where it can be released, thereby preventing additional pressure from being applied to the bladder. The pressure required to fully retract the spring 39 will depend upon the length of the spring and the spring constant (according to Hooke's law).

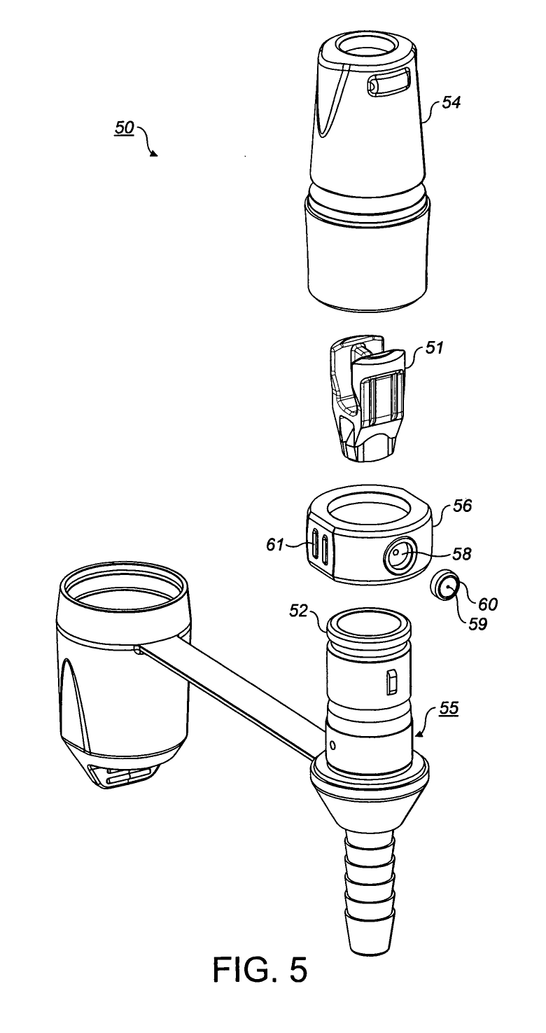

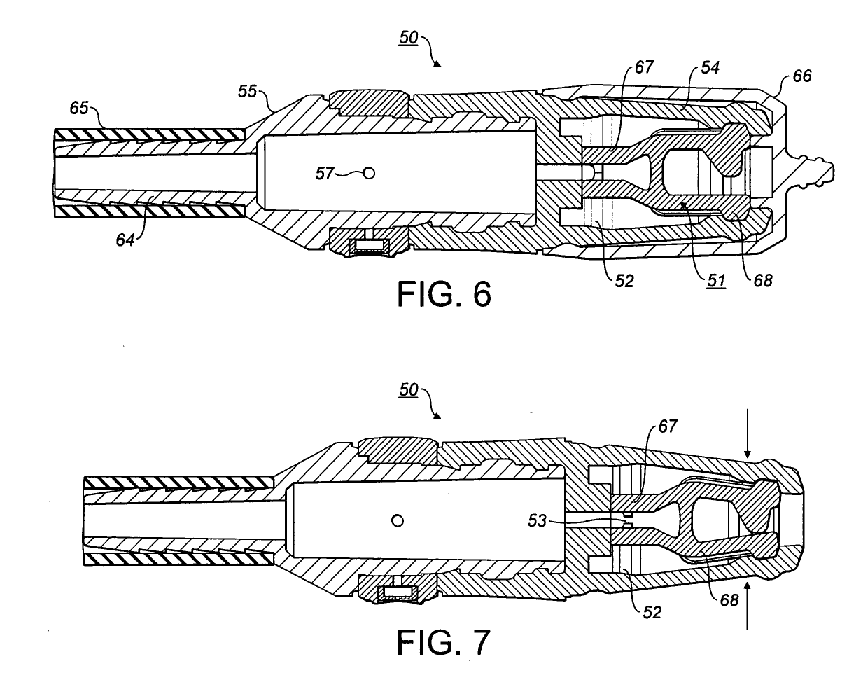

FIGS. 4 to 7 show an example of a bite valve mouthpiece assembly 50 in accordance with the present invention. Although it has particular utility in the hydration pack of FIG. 1 it will be understood that it can be used in other applications.

The mouthpiece 50 incorporates a novel bulldog clip bite valve 51 which acts on a silicon valve 52 having an opening 53. The mouthpiece 50 has a soft outer bite part 54 which push-fits onto a tube connector 55. Coupled to the tube connector 55 is a spray ring 56 which is hand actuated by twisting it around the tube connector 55. When the spray ring 56 is located in the correct position water will pass through a passage 57 in the tube connector 55, through a hole 58 in the spray ring 56, and on through a fine hole 59 in a spray head insert 60. The water flowing through the spray head insert 60 will form a fine mist. Protrusions 61 located on the spray ring 56 are provided to enable the user to easily find the spray ring 56 by touch alone. They also act as grip to turn the spray ring 56. There could be multiple spray head inserts inserted around the spray ring which would allow the user to select different forms of spray or to create multiple sprays.

Located at the upper end of the soft outer bite part 54 are protrusions 62 which act as an aid to the user when biting down onto the outer bite part 54. They also function to stop the user's teeth slipping off the bite part 54. When necessary, the user can use his fingers to deform the bite part 54 rather than use his teeth.

The shape of the bite part 54 is designed so that it fits ergonomically into the user's mouth. Conical shaped protrusions 63 located on opposite sides of the bite part 54 are designed to help the bite part 54 maintain its shape.

At the base of the tube connector 55 is a connector port 64 which allows for easy coupling of the tube connector 55 to a drinking tube 65. The connector port 64 shown is of the barbed connector type however this could be a push-fit type connector or other type of connector.

An end cap 66 is designed to snap-fit directly over the outer bite part 54.

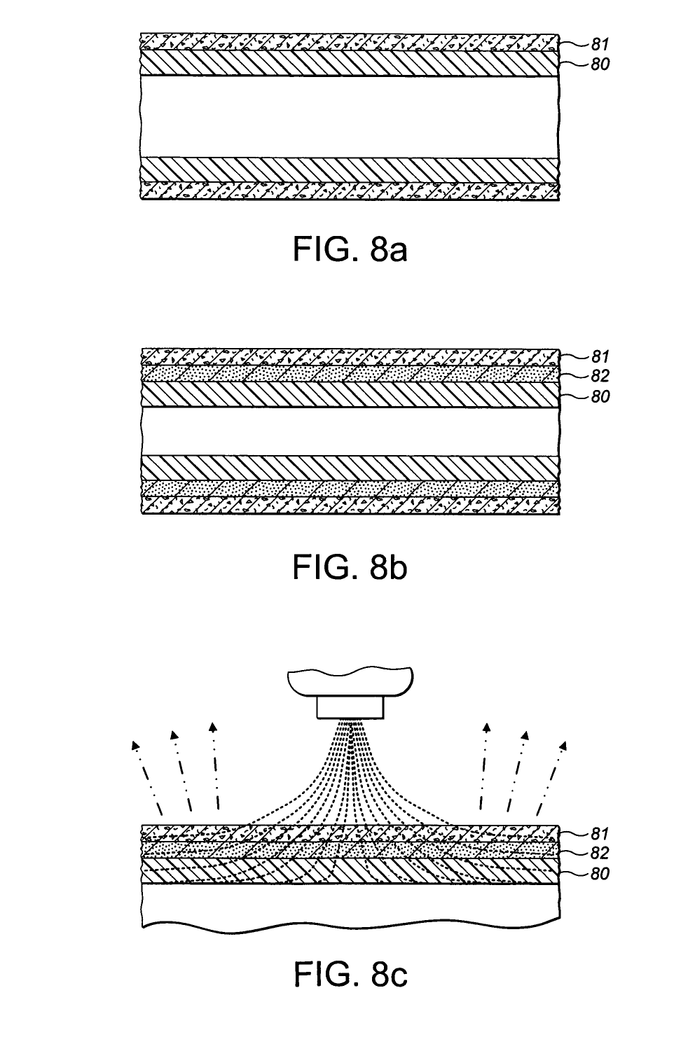

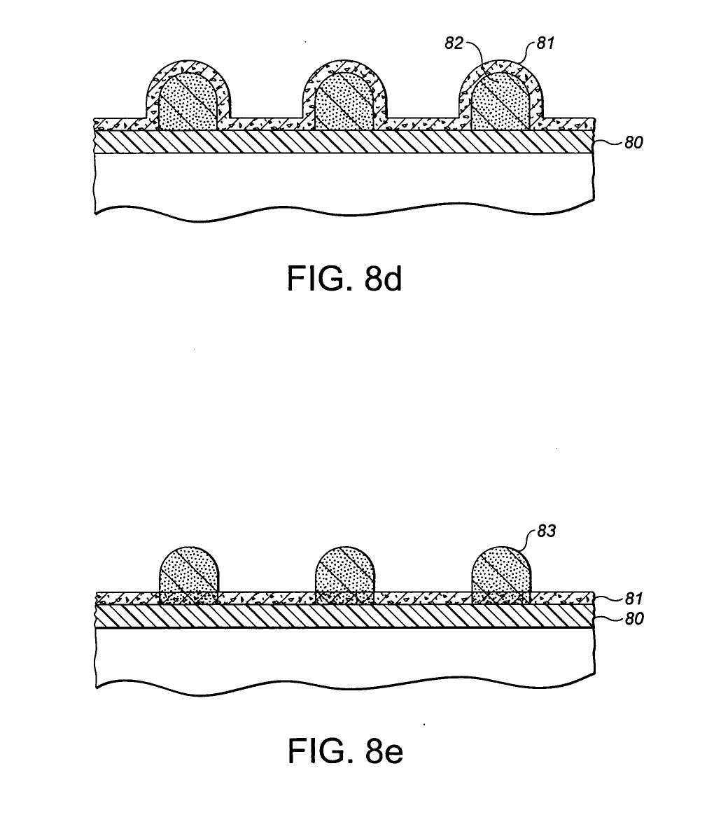

FIGS. 6 and 7 show cross-sectional views of the bite valve mouthpiece assembly 50. FIG. 6 shows the mouthpiece assembly 50 in its closed position preventing water from escaping from the mouthpiece, with the end cap 66 fitted. The bite valve 51 is shown in its naturally closed position. The arms 67 of the bite valve 51 compress the silicone valve 52 so that it closes the opening 53 preventing the flow of water. As shown in FIG. 7, with the end cap 66 removed, when the user applies a biting action to the arms 68 of the bite valve 51 the arms 67 of the bite valve 51 open allowing the opening 53 in the silicon valve 52 to open thereby allowing water to flow. The user may control the rate of flow of water through the mouthpiece by controlling the opening of the bulldog clip bite valve.

The bite valve 51 described above seals the mouthpiece effectively, thereby negating any requirement for additional locking valves that must be actuated separately. Moreover, the bite valve is able to cope with the potential pressure in the bladder without leaking.

In use, the positive pressure differential that exists in the bladder upstream of the mouthpiece 50 also reduces the risk of contamination as it prevents microbiological contamination being drawn back into the mouthpiece 50, down the drinking tube 65 and back into the bladder.

Preferred embodiments of the present invention also address the issue of controlling water temperature. Particularly in hot climates, water within the bladder and drinking tube is heated to the extent that it can become unpalatable. It may also increase the rate of bacteriological growth within the bladder. There is a need to find a solution to help keep the water cool.

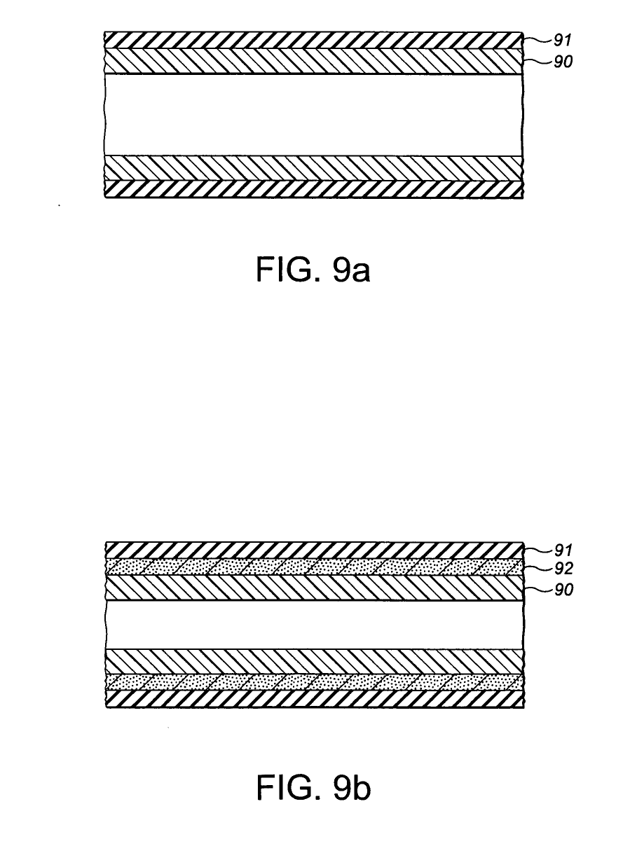

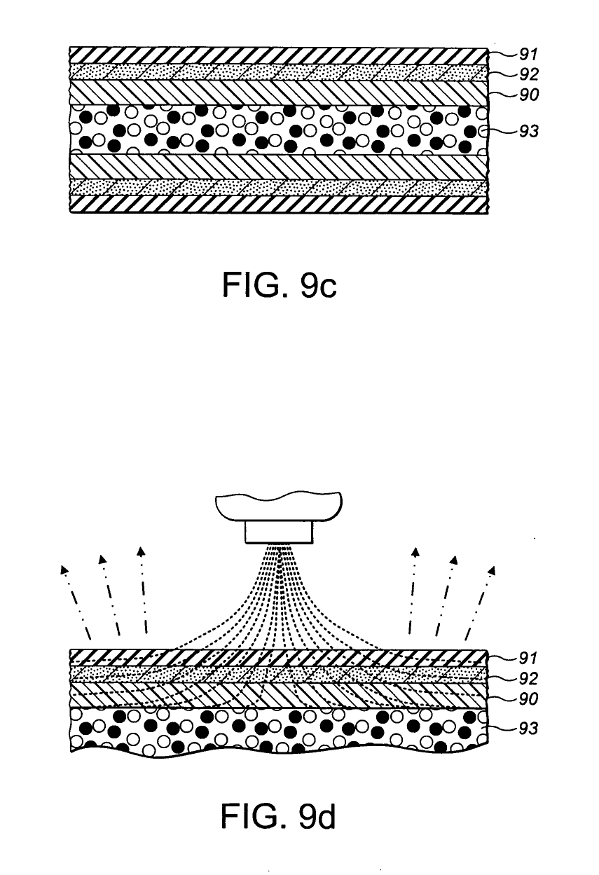

In the preferred embodiments shown in FIGS. 8 and 9, the hydration pack incorporates evaporative cooling materials to provide evaporative cooling for the hydration bladder 80 and/or the drinking tube 90. Suitable evaporative cooling materials include cotton, linen, canvas, non-woven synthetic material, Cordura™ from DuPont, cellulose sponge cloth, and other highly adsorbent materials.

As shown in FIGS. 8A and 9A, respectively, a layer 81, 91 of these materials can be used to cover the wall of the hydration bladder 80 and/or the wall of the drinking tube 90.

As shown in FIGS. 8B and 9B, a layer of highly adsorbent gel 82, 92, such as silica gels, may also be incorporated to further enhance the evaporative cooling effect. Furthermore the hydration bladder 80 and the drinking tube 90 may be made from a thermo-conductive plastic. This makes the evaporative cooling process even more effective.

As shown in FIGS. 8D and 8E respectively, the gel 82 could be encased within ribs of material 81 over portions of the surface of the bladder 80 or instead gel ribs 83 could be applied to the outer material 81 which permeate through the outer material 81 so as to be in good thermal contact with the bladder 80.

As shown in FIG. 9C, the feed tube and/or the drinking tube 90 may contain activated carbon and ion exchange resins 93. These may be in the form of powder or compressed into spheres. These spheres may vary in size so as to allow greater flow of liquid through the interstitial space between the spheres. These spheres may run the entire length of the tube 90 or they may only partially occupy the tube. They are designed to reduce/remove various chemical contaminates. The ion exchange resin is designed to remove salts, and other chemicals present in the water. Such a tube may be replaced when it has expired.

As illustrated in FIGS. 8C and 9D generally, when these evaporative cooling materials are wetted, water is adsorbed into the materials. Through the physics of evaporation, heat is drawn from the drinking water in the hydration bladder and the drinking tube through the adsorbent materials to help cool the drinking water.

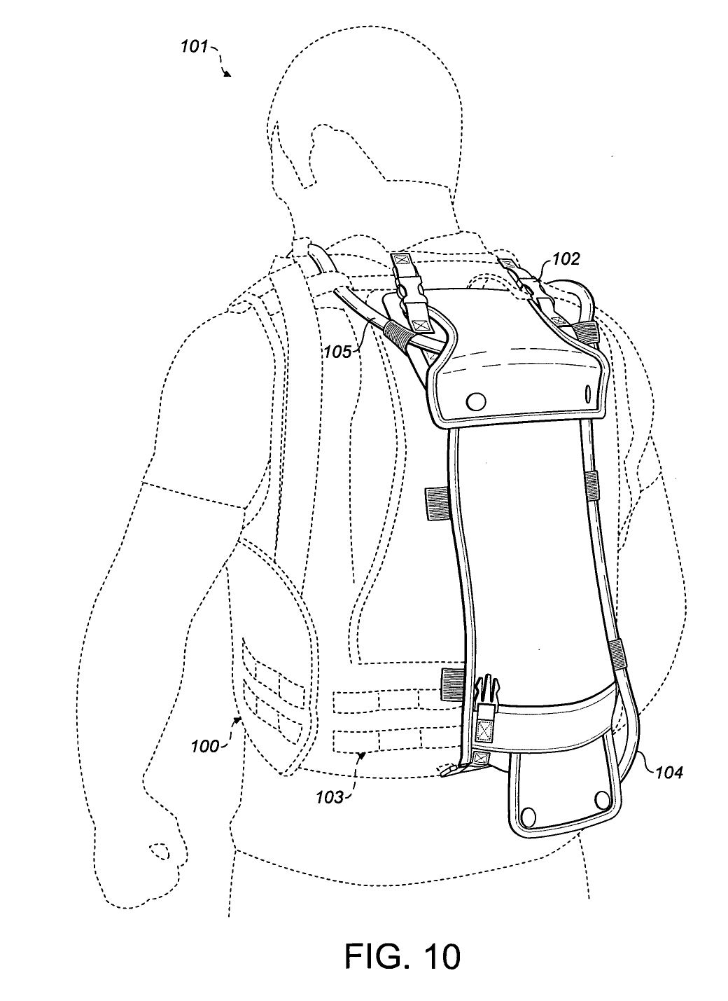

FIG. 10 shows a hydration pack 100 in accordance with the present invention worn by a soldier 101. The hydration pack 100 has clips 102 that allow it to be attached to a molle based system incorporating PALS 103. As shown, the drinking tube 104 and feed tube are stowed neatly, with the associated pump and scavenging tube carried safely elsewhere.

1. A hydration pack comprising:
a hydration bladder for holding water;
a pump having a fluid inlet for drawing in water under the action of the pump and a fluid outlet coupled to the hydration bladder for transferring said water to the hydration bladder; and
a water filter coupled to receive water from the hydration bladder;
a bite valve mouthpiece coupled to the water filter by a drinking tube, for controlling the flow of water from said water filter,
wherein the pump is also operative to transfer air from the pump inlet to the pump outlet so that, in use, the pump can fill the hydration bladder with water from a source and pressurise the hydration bladder with air.

2. (canceled)

3. A hydration pack according to claim 1, wherein the water filter is located within the hydration bladder.

4. A hydration pack according to claim 3, wherein the water filter is removable from the hydration bladder.

5. A hydration pack according to claim 3, wherein the water filter comprises one or more hollow fibre membranes which are effective to pass water in preference to air under the influence of a pressure differential.

6. A hydration pack according to claim 5, wherein the membranes are hydrophilic.

7. A hydration pack according to claim 3, wherein the water filter has a mean pore size of less than or equal to 25 nanometres.

8. A hydration pack according to claim 3, wherein the water filter has a retention of greater than log 6 (99.9999%) of bacteria, cysts, parasites and fungi, and greater than log 4 (99.99%) of viruses from water.

9. A hydration pack according to claim 3, wherein the bite valve mouthpiece comprises a valve member having a valve opening and a bulldog clip closure which normally closes the valve opening to prevent the flow of water, the bulldog clip being flexed open when a user bites down to release the valve opening and thus allow water to flow through the mouthpiece.

10. A hydration pack according to claim 9, wherein the bulldog clip closure comprises two arms disposed around a pivot region, the arms having corresponding bite regions and constriction regions disposed on opposite sides of the pivot region, and the arms being biased towards a position in which constriction regions of each arm are urged toward each other to seal the valve member.

11. A hydration pack according to claim 9, wherein the bite valve mouth piece comprises an atomiser portion actuable to deliver a spray mist of water.

12. A hydration pack according to claim 1, further comprising a removable closure.

13. A hydration pack according to claim 1, wherein the pump is manually actuated.

14. A hydration pack according to claim 1, wherein the pump includes a pressure regulator to release pressure when it passes a predetermined threshold value.

15. A hydration pack according to claim 1, further comprising one or more evaporative cooling materials to provide evaporative cooling for the hydration bladder and/or the drinking tube.

16. A hydration bladder according to claim 1, wherein the drinking tube and the hydration bladder are made from a thermo-conductive plastic.

17. A hydration pack according to claim 1, further comprising clips for attaching the hydration pack to a personal load carriage system.

18. A bite valve mouthpiece comprising a valve member having a valve opening and a bulldog clip closure which normally closes the valve opening to prevent the flow of water, the bulldog clip being flexed open when a user bites down to release the valve opening and thus allow water to flow through the mouthpiece.

19. A bite valve according to claim 18, wherein the bulldog clip closure comprises two arms disposed around a pivot region, the arms having corresponding bite regions and constriction regions disposed on opposite sides of the pivot region, and the arms being biased towards a position in which constriction regions of each arm are urged toward each other to seal the valve member.

20. A bite valve according to claim 18, further comprising an atomiser portion actuable to deliver a spray mist of water.

21-25. (canceled)

26. A hydration pack according to claim 3, wherein the water filter has a mean pore size of less than or equal to 20 nanometres, and more preferably less than or equal to 15 nanometres.
